(19) United States
(12) Patent Application Publication
(10) Pub. No.: US 2024/0428201 A1
(43) Pub. Date: Dec. 26, 2024

(54) APPROACHES FOR DETERMINING A CYCLE TIME IN A SOFTWARE PROJECT

(71) Applicant: CODESCENE AB, Malmö (SE)

(72) Inventor: Adam TORNHILL, Malmö (SE)

(21) Appl. No.: 18/701,298

(22) PCT Filed: Oct. 11, 2022
(86) PCT No.: PCT/EP2022/078166

§ 371 Date: Apr. 15, 2024

(30) Foreign Application Priority Data
Oct. 15, 2021 (SE) 2151266-0

(51) Int. Cl. G06Q 10/1091; G06F 8/71

(52) U.S. Cl. CPC G06Q 10/1091; G06F 8/71

(57) ABSTRACT

A computer-implemented method is disclosed for determining a cycle time in a software project. The method includes obtaining a task data item by accessing project management data, wherein the project management data is indicative of migration of software project tasks through different project phases including an in-progress phase. The task data item includes a task identifier indicating a task corresponding to the task data item, and a task time stamp indicating when the task migrated to the in-progress phase. The method also includes obtaining a version control data item by accessing version control data, wherein the version control data is indicative of software commits of the software project. Corresponding apparatus and computer program product are also disclosed.

### TECHNICAL FIELD

The present disclosure relates to methods for determining a cycle time in a software project, computer program products and apparatuses. More specifically, some embodiments of the disclosure relates to a method for determining a cycle time in a software project, a computer program product and an apparatus; for example as defined in the introductory parts of the independent claims.

### BACKGROUND

Mature software organizations typically measure throughput metrics in order to track the efficiency of their development organization. Metrics are possible to calculate directly from a project management tool such as, for example, Jira or Trello. A problem with the solutions of the prior art is that this data is not actionable since it is not possible to trace to specific bottlenecks in the software design. There is thus a need for alternative approaches; for example, improved and automated detection of bottlenecks in the development process.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

It is an object of the present disclosure to mitigate, alleviate or eliminate one or more of the above-identified deficiencies and disadvantages in the prior art and solve at least the above mentioned problem. It is an object of some embodiments to solve or mitigate, alleviate, or eliminate at least some of the above or other disadvantages.

A first aspect is an electronic data-processing apparatus configured for determination of a cycle time in a software project. The cycle time relates to a software project file—or collection of files—in the software project.

The apparatus comprises controlling circuitry configured to cause a task data item to be obtained by accessing project management data stored on first memory circuitry associated with the apparatus. The project management data is indicative of migration of software project tasks through different project phases including an in-progress phase. The task data item comprises a task identifier indicating a task corresponding to the task data item, and a task time stamp indicating when the task migrated to the in-progress phase.

The controlling is also circuitry configured to cause a version control data item to be obtained by accessing version control data stored in second memory circuitry associated with the apparatus. The version control data is indicative of software commits of the software project. The version control data item relates to one or more software commit and comprises (for each related software commit) a commit-specific version control time stamp indicating when the software commit was performed. and a commit-specific list of software project files that were modified in association with the software commit.

The controlling is also circuitry configured to cause—responsive to the version control data item being linked to the task data item—determination of the cycle time of a software project file in a commit-specific list by determination of time duration between the task time stamp and the version control time stamp specific for the commit of the commit-specific list.

In some embodiments, the controlling circuitry is further configured to cause the cycle time of the software project file to be stored in third memory circuitry.

In some embodiments, the controlling circuitry is further configured to cause linking of the version control data item to the task data item when the software commits of the version control data item are performed for the task corresponding to the task data item.

In some embodiments, the controlling circuitry is further configured to cause linking of the version control data item to the task data item when the version control data item pertains to the task identifier of the task data item.

In some embodiments, the version control data item pertaining to the task identifier of the task data item comprises one or more of: the task identifier appearing in a code comment of a software project file in a commit-specific list of the version control data item, the task identifier being indicated for a version control branch comprising the one or more software commit of the version control data item, and the task identifier being indicated for a pull request, or a merge request, invoking the one or more software commit of the version control data item.

In some embodiments, the version control time stamp used for the determination of the cycle time of the software project file indicates the last commit of the version control data item that has the software project file in its commit-specific list.

In some embodiments, the controlling circuitry is further configured to cause determination of the cycle time of a software project file in a commit-specific list by determination of contributory time duration between an earlier version control time stamp and the version control time stamp specific for the commit of the commit-specific list, wherein the earlier version control time stamp is specific for a commit which is indicated by the version control data item.

In some embodiments, the earlier version control time stamp is specific for a commit which is directly previous to that of the commit-specific list.

In some embodiments, the controlling circuitry is further configured to cause, for a software project file, determination of contributory time duration for a plurality of commits that each have the software project file in their commit-specific list, and determination of the cycle time of the software project file by combination of contributory time durations.

For example, the software project file may be a first software project file, and the earlier version control time stamp may be specific for a commit which has another—second—software project file in its commit-specific list.

In some embodiments, modification of the first software project file is conditioned on modification of the second software project file being completed.

In some embodiments, modifications of the first and second software project files are associated with a same developer identity.

In some embodiments, the controlling circuitry is further configured to cause determination of an intermediate cycle time for each of a plurality of combinations of task data item and version control data item of the software project, and provide the cycle time of the software project file as a combination of the intermediate cycle times.

In some embodiments, the controlling circuitry is further configured to cause determination of the cycle time of a software project collection of files as a combination of the cycle times of software project files in the collection.

In some embodiments, the version control data item further comprises, for each related software commit, a version identifier indicating the software commit.

A second aspect is a computer-implemented method for determining a cycle time in a software project. The cycle time relates to a software project file—or collection of files—in the software project.

The method of the second aspect comprises obtaining a task data item by accessing project management data stored on first memory circuitry, wherein the project management data is indicative of migration of software project tasks through different project phases including an in-progress phase. The task data item comprises a task identifier indicating a task corresponding to the task data item, and a task time stamp indicating when the task migrated to the in-progress phase.

The method of the second aspect also comprises obtaining a version control data item by accessing version control data stored in second memory circuitry, wherein the version control data is indicative of software commits of the software project, and wherein the version control data item relates to one or more software commit. The version control data item comprises (for each related software commit) a commit-specific version control time stamp indicating when the software commit was performed, and a commit-specific list of software project files that were modified in association with the software commit.

The method of the second aspect also comprises, responsive to the version control data item being linked to the task data item, determining the cycle time of a software project file in a commit-specific list by determination of time duration between the task time stamp and the version control time stamp specific for the commit of the commit-specific list.

A third aspect (that may, for some embodiments, be combined with the second aspect) is a computer-implemented method for determining a cycle time in a software project, at an electronic device comprising a processing unit and a memory on which project management data and version control data is stored. In some embodiments, also project artefacts are stored on the memory.

The method of the third aspect comprises obtaining from the project management data, on the processing unit, a task data item. The task data item comprises at least one task time stamp and a task ID.

The method of the third aspect also comprises obtaining from the version control data, on the processing unit, a version control data item. The version control data item comprises a version ID, at least one version control time stamp, and a first list of modified project data files associated with the version ID.

The method of the third aspect also comprises linking, on the processing unit, each version control data item to at least one task data item.

The method of the third aspect also comprises determining, on the processing unit, the cycle time for each modified project data file, wherein the cycle time is based on the task data items and/or version control data items associated with the file.

The method of the third aspect may also comprise storing the cycle time for each modified project data file on the memory.

Thus, according to the third aspect there is provided a method for determining a project task time in a software project (e.g., relating to a software project file—or collection of files—in the software project), at an electronic device comprising a processing unit and a memory on which project management data (e.g., indicative of migration of software project tasks through different project phases including an in-progress phase), and version control data (e.g., indicative of software commits of the software project) is stored. In some embodiments, also project artefacts are stored on the memory.

The term “project task time” is to a large extent used interchangeably with the term “cycle time” herein.

The method comprises obtaining from the project management data, on the processing unit, a task data item, wherein the task data item comprises at least one task time stamp (e.g., indicating when the task migrated to the in-progress phase) and a task ID (e.g., indicating a task corresponding to the task data item), and obtaining from the version control data, on the processing unit, a version control data item (e.g., relating to one or more software commit), wherein the version control data item comprises (e.g., for each related software commit) a version ID (e.g., indicating the commit), at least one version control time stamp (e.g., indicating when the commit was performed), and a first list of modified project data files associated with the version ID (e.g., a commit-specific list of software project files that were modified in association with the commit).

Generally, the notation “ID” is meant to have any suitable meaning, e.g., “identifier”, “identity”, or any other commonly known meaning.

The method may further comprise linking, on the processing unit, the version control data item to at least one task data item. For example, a plurality of version control data items may be obtained and the method may comprise linking, on the processing unit, each version control data item to at least one task data item.

The method may further comprise determining, on the processing unit, the project task time for each modified project data file, wherein the project task time is based on the task data item(s) and/or version control data item(s) associated with the file.

The method may further comprise storing the project task time for each modified project data file on the memory.

Mature software organizations typically measure throughput metrics and project task times in order to track the efficiency of their development organization. Project task time metrics are possible to calculate directly from a product management tool such as, for example, Jira or Trello. A problem with the solutions of the prior art is that this data is typically not actionable since it is not possible to trace to specific bottlenecks in the software design. Further, product management software typically requires users to consciously act, e.g. changing the status of a task.

This means that even if the organization knows their overall project task times for tasks (e.g., features, bug fixes, etc.), there are large variations depending on where in the codebase the (related) changes take place; some parts of the system might be easy to modify, while others are highly complex (to modify).

Here, approaches (e.g., a method) are disclosed for determining cycle time in a software project, where project task time represents the time it takes for a task to be done (e.g., per file, and/or per collection of files). The determination may be done at an electronic device comprising a processing unit and a memory, for example, a computer or a smart phone. According to some embodiments, the electronic device stores, inter alia: project management data, such as data from Jira or Trello; and version control data, such as data from Mercurial, Git, or SVM. In some embodiments, also project artefacts, such as data concerning product backlogs, sprint backlogs, and/or increments, are stored on the memory.

The disclosure further comprises obtaining a task data item from project management data and a version control data item from version control data, then using their respective time stamps to calculate a project task time. The calculation may be done, for example, by determining the time difference(s) between two or more time stamps. The task data item and the version control data item are linked, for example, by a task ID.

The resulting project task time may be associated with project files that have been modified in relation to the version control data and/or the project management data. The project task time may be, for example, the sum of the first task times associated with a modified project data file (as exemplified further in FIG. 11A). The project task time may then be stored on the processing unit, for each of the modified project data files.

Determining the project task time and associating it with a modified file or set (collection) of modified files allows the identification of specific components of the software (codebase) that are more time-consuming, and therefore expensive, than others (to modify). Further, the use of time stamps allows this calculation to be automatically performed by the machine (e.g., the electronic device), rather than relying on a person (e.g., performing steps) to estimate the time. Some embodiments of the disclosure allows (e.g., provision of) a technical measure of a previously subjective property, i.e., how much work (e.g., time) a part of a project (e.g., modification of a file or a collection of files) takes.

Further, the automated identification of these components (e.g., files, or collections of files, that require relatively long time for modification) allows for the efficient and also automated allocation of resources to deal with the more difficult components of the software. For example, based on such a calculation, future maintenance may be planned, future hours required, or other resources allocated.

According to some embodiments, the electronic device further comprises a display unit: displaying, on the display unit, the project task time for at least one of the modified project data files.

By displaying the newly calculated project task times, particularly in some of the embodiments described below, e.g., a sortable list, the display supports the user in performing a technical task of identifying the most time-consuming components of the software project.

According to some embodiments, the method comprises: determining a cycle time, wherein the cycle time is a project task time based on a first task time (e.g., a time duration), wherein the first task time is based on the time between a first task time stamp for a first project phase (e.g., the task time stamp indicating when the task migrated to the in-progress phase) and an second task time stamp for a first project phase (e.g., a time stamp indicating when the task migrated from the in-progress phase).

In some embodiments, a project task time may be a cycle time. Project management software typically includes project phases such as “To do”, “In progress”, “Done”, etc. Task data items may be moved through the different phases, and may be associated with project data files. Therefore, a first task time may be determined by time stamps associated with the task data item, such as the beginning time stamp and the end time stamp for the “in progress” phase. This first task time may be linked to the project data files by the task data item, for example, through a task ID attached to the metadata of the project data file. Once at least one first task time is determined for a project data file, a (type of) cycle time may be determined from the first task time, for example, as a sum of all first task times.

This method of calculating a cycle time uses the information available from the product management software to evaluate the software components, allowing the automatic determination of the impact of a software component based on the time consumed between tasks.

According to some embodiments, the method comprises: determining a lead time, wherein the lead time is based on a second task time, wherein the second task time is based on the time between the first task time stamp for the first project phase (e.g., a task time stamp indicating when the task migrated to a particular phase) and a third task time stamp for a second project phase (e.g., a time stamp indicating when the task migrated from a project phase subsequent to the particular phase).

In an embodiment, a project task time may be a cycle time. Here, more than one project phase may be used to calculate a second task time, in a manner similar to determining a first task time. For example, by determining the difference in time from a the beginning time stamp of the “To Do” phase to the end time stamp of the “In progress” time stamp.

This method of calculating a lead time uses the information available from the product management software to evaluate the software components (e.g., files and/or collection of files), allowing the automatic determination of the impact (e.g., on required time for task completion) of a software component based on the time consumed overall (e.g., for the software component). By using additional information (e.g., from the version control data), an alternative way of automating the measurement of impact is enabled.

According to some embodiments, the method comprises; obtaining a person ID for each change made in the modified project files of the first list of modified project data files; in response to determining that all changes are associated with the same person ID: determining the project task time based on a second task time, wherein the second task time is based on the time between a second task time stamp for the first project phase (e.g., a task time stamp indicating when the task migrated from a particular phase) and a third task time stamp for a second project phase (e.g., a time stamp indicating when the task migrated from a project phase subsequent to the particular phase).

In an embodiment, a project task time for a single person may be determined without accounting for all steps in between, since it can be presumed that a single person is not simultaneously in two phases on a single task. Thus, a second task time can be determined based on time stamps from different project phases with the assumption that the time was continuous. It may, e.g., be known from the project management data that a task, or commit, has to be done before another task, or commit, if the tasks, or commits, are performed by a single person.

According to some embodiments, the task data item further comprises at least one person ID, and the method further the method comprises: determining that all tasks and/or all modified project data files are associated with the same person ID.

A person ID is associated with a person, and may be, for example, a unique user ID. A person (e.g., via the person ID) may be attached to (associated with) data items from the project management data and the version control data as well. The use of a person ID allows for task data items, modified project data files, and other data items to be associated with a (single) person.

An advantage of this is that it enables not only the components to be identified, but the identification of a person with the most experience for those components, thus permitting automated measurement of a person's experience with a given software component. This further allows the selection of more experienced persons for future tasks involving the person, whether through a user interface or automatic selections from the software.

According to some embodiments, the method comprises: determining the project task time based on a task version time (e.g., time duration), wherein the task version time is based on the time between a version control time stamp from the version control data item (e.g., the task time stamp indicating when the task migrated to the in-progress phase) and a task time stamp from the task data item corresponding to the version control data item (e.g., a version control time stamp specific for a commit where the file under consideration was modified; and consequently included in the commit-specific list).

Determining project task time based on the combination of project management data and version control data increases the accuracy of calculating project task time through an automated process. Version control data from when a software component was actually checked in (committed) can be combined with project management data (e.g., from when the software component was reported to be checked in), resulting in a better measurement of how long (modifications related to) a task takes. Further, by using available version control data and the project management data, this determination may be automated.

Further, product management software typically requires users to consciously act, e.g. changing the status of a task. By using the version control data item, the project task time can be determined incidental to the user's other actions, e.g., when they check in a version of the project data files into the version control system. For example, conclusion of a phase may be implied based on when a version of the project data files is checked in to the version control system.

According to some embodiments, the method comprises: determining an impact measure based on an amount of modification of the modified project data files for each version control data item, and storing on the memory the impact measure for at least one version control data item.

In an embodiment, an impact measure may be determined for the modified project data files, allowing measurement and sorting of the data files based on their impact. This allows more accurate estimates of the workload required for a given software component, which will make the project easier to manage which in turn will result in a better software product.

According to some embodiments, the amount of modification is the number of lines of code changed for each modified file corresponding to the version control data item.

According to some embodiments, the memory further stores software configuration data comprising architectural component information associated with each project artefact, the method further comprising: retrieving a second list of modified project data files associated with an architectural component (e.g., a collection of files), and determining an architectural component project task time for an architectural component based on all project task times for the modified project data files associated with the architectural component.

As individual project data files are often part of larger architectural components, it may be advantageous to measure project task time for the architectural components as well, as to allow automated identification of which architectural components are bottlenecks for the project and the automation of priorities. By offering different levels of granularity in measuring the problem (e.g., time consumption for modifications), it may be easier to determine whether a particular grouping (collection) of related project data files results in higher project task times compared to other such groupings.

According to some embodiments, the architectural component project task time is based on all project task times using a calculation comprised in the group of: the sum of all project task times, the mean value of all project task times, the median value of all project task times, the variance of all project task times, the standard deviation of all project task times.

Project task times may be measured in different ways, and it may be useful to offer both absolute and comparative measures. For example, if the same architectural component in two different projects has two different summed project task times, it may be an issue with the project and the not the component. A relative measure may be useful, for example, in determining the allocation of future person hours.

According to some embodiments, the second list of modified project data files is retrieved by mapping names of the modified project data files of first list of modified project data files using a preconfigured rule.

In an embodiment, a second list of modified data project files may be retrieved, i.e. from another data system containing the project data files. This allows further information on the project data files from the other data system to be automatically added. The other data system may contain, for example, software configuration data.

According to some embodiments, the method comprises: calculating a second architectural component project task time for a second architectural component; and comparing the first and second architectural component project task times.

By comparing two architectural components, one can identify at the level of the architectural components which components may require more future maintenance, more future hours, or other resources allocated. At different levels of granularity, different measurements may be made, and trends identified accordingly.

According to some embodiments, the method further comprises wherein the first list and/or the second list of modified project data files is based off the metadata of the modified project data files without the contents of the files, and the project task time for each modified project data file is stored as metadata on the file.

Using the metadata of the project data files is a technical method that allows the content of the data files to be kept confidential. This may be important for regulatory purposes, e.g. concerning data privacy.

According to some embodiments, the method comprises: determining for the modified file, or the architectural component, a ranking based on the impact measure and/or the task time of the modified file, or the architectural component.

By ranking the files and/or the architectural components, one can identify which file and/or architectural component may require more future resources, such as person hours to work on it. This allows automating the prioritization of tasks associated with such components.

According to some embodiments, the method comprises sorting the first list of modified project data files based on the project task time for each modified file, and displaying on the display unit the sorted list of modified project data files.

According to some embodiments, the method comprises sorting a list of architectural components based on the architectural component project task time for each architectural component, and storing on the memory the sorted list of architectural component.

By displaying lists of software components, e.g. modified project files, and/or architectural components, as sorted lists, the display assists the user in the technical task of allocating resources to such software components.

According to a fourth aspect, there is provided a computer program product comprising a non-transitory computer readable medium, having thereon a computer program comprising program instructions, the computer program being loadable into the processing unit and configured to cause execution of the method according to any of the first and second aspects when the computer program is run by the processing unit.

According to a fifth aspect there is provided an apparatus comprising controlling circuity for performing the method of any of the second and third aspects.

In some embodiments, any of the aspects may additionally have features identical with or corresponding to any of the various features as explained for any of the other aspects. For example, effects and features of the fourth and fifth aspects may to a large extent be analogous to those described above in connection with the third aspect. Embodiments mentioned in relation to the third aspect are, according to some embodiments, largely compatible with the fourth and fifth aspects.

An advantage of some embodiments is that-compared to other approaches-more accurate and/or useful indications of time consumption for modifications is achieved in relation to tasks in a software project.

An advantage of some embodiments is that time consumption indications (cycle times) may be provided at a higher granularity than for other approaches (e.g., per file and/or per collection of files; as opposed to per task for other approaches).

An advantage of some embodiments is that time consumption indications (cycle times) provided per file, and/or per collection of files, may be combined for two or more tasks and/or may be compared between two or more tasks.

An advantage of some embodiments is that time consumption indications (cycle times) may be provided which are more accurate than for other approaches (e.g., in that they are closer to an actual time spent on code modification; excluding—for example—queueing time, time when a file is checked out but not actively modified, time for testing and verification, and similar).

According to some embodiments, cycle times are updated over time (e.g., at least once, but typically repeatedly). For example, cycle times may be updated responsive to one or more type of event (e.g., when a task migrates from the in-progress phase, when a task is indicated as completed, etc.).

An update of a cycle time may comprise completely discarding a previous value of the cycle time and replacing it with a newly determined value of the cycle time, or an update of a cycle time may comprise combining a previous value of the cycle time with a newly determined value of the cycle time. For example, a filter may be applied that successively phases out old values of the cycle time. Alternatively or additionally, a previous value of the cycle time which was based on a combination of cycle time values associated with different tasks may be updated by determining the combination using a newly determined value of the cycle time for one or more tasks and a previously determined value of the cycle time for one or more other tasks.

Updating cycle times over time enables continuous guidance to a user (e.g., a project manager or a developer) regarding which portions (e.g., files, and/or collections of files) of the codebase require relatively long time for modification. Alternatively or additionally, comparison of cycle times over time and between tasks enables continuous guidance to a user regarding which tasks include problematic code modification, and hence may require relatively long time for completion.

The user is guided to focus efforts on such portions of the codebase and/or such tasks, and the updates provides repetitive feedback regarding whether the efforts were successful or not (e.g., whether the cycle times have decreased and/or the problematic code modification of a task has improved).

Focusing efforts to a code portion and/or task may, for example, include one or more of: assigning a particularly experienced developer to the code portion and/or task, assigning a relatively high amount of developers to the code portion and/or task, using a relatively potent development tool for the code portion and/or task (e.g., efficient compiler, programming tool, code streamlining tool, automated—or semi-automated—programming such as machine learning programming or artificial intelligence programming, etc.), and improving the code base to make it less time consuming to modify going forward.

In some embodiments, a cycle time improvement task may (e.g., automatically) be created and entered into the project management tool, responsive to the determined cycle time(s). For example, the cycle time improvement task may have the object of improving the code base to make it less time consuming to modify going forward. In some embodiments, the cycle time improvement task may be (e.g., automatically) updated, responsive to cycle time update(s). In some embodiments, the cycle time improvement task may be (e.g., automatically) marked complete, responsive to fulfillment of a cycle time conditions (e.g., cycle time value below an absolute or relative threshold value).

An advantage of some embodiments, is that the cycle time(s) can be dynamically updated (e.g., to provide feedback on performed efforts (e.g., development/maintenance efforts) and/or keep guidance up to date regarding which portions of code and/or which tasks are associated with most time consuming modification.

An advantage of some embodiments, is that improved guidance is provided regarding which portions of code and/or which tasks are most relevant for focusing efforts on.

An advantage of some embodiments is that the cycle time(s) may be presented to a user to guide the user to perform the technical task of improving the code base to make it less time consuming to modify going forward. By presenting dynamically updated cycle time(s), continued guidance may be provided in the form of human-machine interaction.

Improving the code base to make it less time consuming to modify going forward may comprise any suitable actions. For example, the code portion(s) with relatively long cycle time(s) may be subjected to changes such as one or more of: re-writing the code, improving code comments, running the code through a streamlining tool, splitting files (and/or collection of files), merging files (and/or collection of files), rearranging the code, etc.

The present disclosure will become (more elaborately) apparent from the detailed description given below. The detailed description and specific examples disclose (possibly preferred) embodiments of the disclosure by way of illustration only. Those skilled in the art understand from guidance in the detailed description that changes and modifications may be made (e.g., within the scope of the disclosure).

Hence, it is to be understood that the herein disclosed disclosure is not meant to limit embodiments to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1A is a flowchart illustrating example method steps according to some embodiments;

FIG. 1B shows an example method for determining a project task time;

FIG. 2A shows an example computer program product comprising a non-transitory computer readable medium;

FIG. 2B is a schematic drawing illustrating an example computer readable medium according to some embodiments;

FIG. 3A shows an example apparatus comprising controlling circuity for performing a method according to some embodiments of the disclosure;

FIG. 3B is a schematic block diagram illustrating an example apparatus according to some embodiments;

FIG. 3C is a schematic block diagram illustrating a system comprising an example apparatus according to some embodiments;

FIG. 4 shows an example product management dashboard and an example effect of some embodiments of the disclosure on modified files;

FIG. 5 shows an embodiment of a table comprising a sorted list of architectural components and a sorted list of modified project data files based on project task time;

FIG. 6 shows how input data is used to calculate granular cycle times at the design level;

FIG. 7 shows an example (7A) of free text data as input into a version control system and an example (7B) of a version-control branch that can be prefixed with a task ID;

FIG. 8 shows an example result of Step 2 and/or Step 3 of FIG. 6, a list of files with cycle time data;

FIG. 9 shows an example of the combination of the transition time stamp from the product management tool with the commit time stamp of the version control tool;

FIG. 10 shows an example result of step 4 of FIG. 6, a list of architectural components with cycle time data;

FIG. 11A shows an example of the combination of the transition time stamp from the product management tool with the commit time stamp of the version control tool (e.g., as in FIG. 9), in some embodiments, this example may be applicable to situations with a single user; and

FIG. 11B is a schematic drawing illustrating an example of the combination of the transition time stamp from the product management tool with the commit time stamp of the version control tool.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

The present disclosure will now be further described with reference to the accompanying drawings, in which some (e.g., preferred) example embodiments of the disclosure are shown. The disclosure may, however, be embodied in other forms and should not be construed as limited to the herein disclosed embodiments. The disclosed embodiments are provided to fully convey the scope of the disclosure to the skilled person.

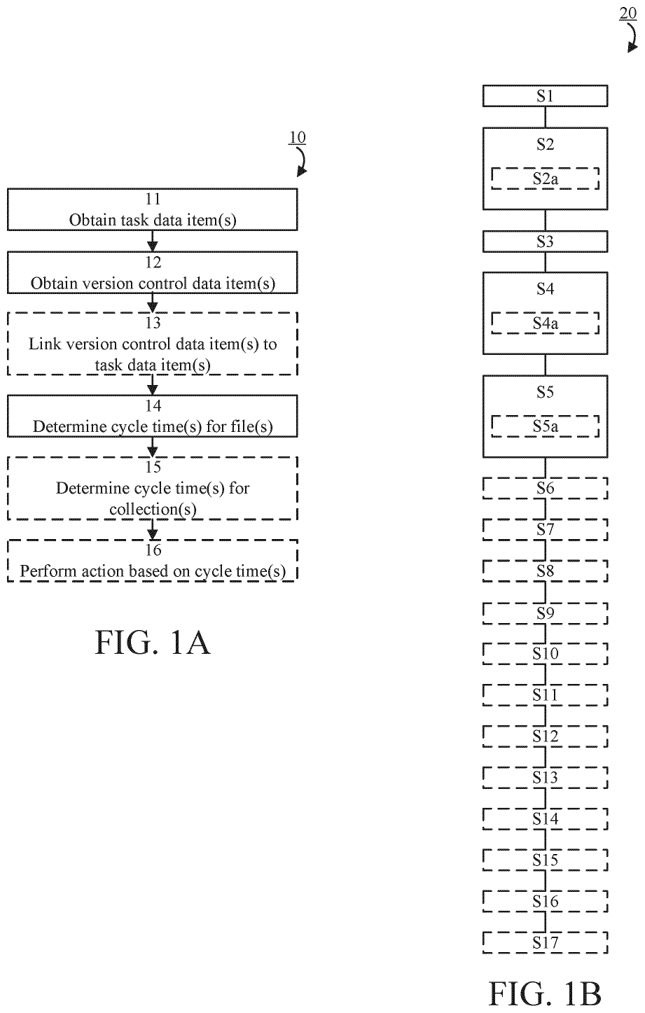

FIG. 1A illustrates an example method 10 according to some embodiments. The method is a computer-implemented method for determining a cycle time in a software project, wherein the cycle time relates to a software project file—or collection of files—in the software project.

The method 10 comprises obtaining a task data item, as illustrated by step 11. The task data item is obtained by accessing project management data stored on first memory circuitry, wherein the project management data is indicative of migration of software project tasks through different project phases including an in-progress phase. Example project management data comprises data from a project management tool such as Jira or Trello.

For example, the in-progress phase may be defined as a phase where actual modifications to the code within files is performed.

The task data item comprises a task identifier indicating a task corresponding to the task data item, and a task time stamp indicating when the task migrated to the in-progress phase.

The method 10 also comprises obtaining a version control data item, as illustrated by step 12. The version control data item is obtained by accessing version control data stored in second memory circuitry, wherein the version control data is indicative of software commits of the software project.

The version control data item relates to one or more software commit and comprises (for each related software commit) a commit-specific version control time stamp indicating when the software commit was performed, and a commit-specific list of software project files that were modified in association with the software commit.

As illustrated by optional step 13, the method 10 may also comprise linking version control data item(s) (e.g., the obtained version control data item) to task data item(s) (e.g., the obtained task data item). In some embodiments, the version control data item(s) are already liked to task data item(s), or are performed independently or the method 10.

In any case, the method 10 also comprises determining cycle time(s) for project code file(s), as illustrated by step 14. The cycle time(s) is determined responsive to the obtained version control data item being linked to the obtained task data item. More particularly, step 14 may comprise determining the cycle time of a software project file in a commit-specific list (of the obtained version control data item) by determining a time duration between the task time stamp (of the obtained task data item) and the version control time stamp of the obtained version control data item) specific for the commit of the commit-specific list.

As illustrated by optional step 15, the method 10 may also comprise determination of cycle time(s) of a software project collection of files. For example, the cycle time of a collection of files may be determined as a combination (e.g., accumulation, averaging, taking the mean value, or similar) of the cycle times of software project files in the collection.

As illustrated by optional step 15, the method 10 may also comprise performing one or more action based on the cycle time(s). For example, step 15 may comprise one or more of: displaying—or otherwise rendering—the cycle time(s) (or information derived therefrom) through a user interface, storing—e.g., in association with in an identifier of the corresponding code portion—the cycle time(s) (or information derived therefrom) in third memory circuitry, providing continuous guidance as exemplified above, and interacting with the project management tool as exemplified above—by creating/updating/removing a cycle time improvement task.

Generally, the first, second, and third memory circuitry may be the comprised in the same storing unit (e.g., memory), or one or more of the first, second, and third memory circuitry may reside in a respective, separate, storing unit.

The linking of the version control data item to the task data item (e.g., performed in step 13) may comprise linking when the software commits of the version control data item are performed for the task corresponding to the task data item. For example, the version control data item may be linked to the task data item when the version control data item pertains to the task identifier of the task data item; e.g., in that the task identifier appears in a code comment of a software project file in a commit-specific list of the version control data item, and/or the task identifier is indicated for a version control branch comprising the one or more software commit of the version control data item, and/or the task identifier is indicated for a pull request (or a merge request) invoking the one or more software commit of the version control data item. Other conditions for linking the version control data item to the task data item are also possible. For example, a task data item may—explicitly or implicitly—identify one or more file (and/or collection of files), and a link may be formed to version control data item(s) that have at least one of the identified files in at least one of its commit-specific list.

The determination of the file cycle time (step 14) may be performed in various ways. This will be further exemplified in connection to FIGS. 9, 11A, and 11B.

In some embodiments, the version control time stamp used for the determination of the cycle time of the software project file indicates the last commit of the version control data item that has the software project file in its commit-specific list. Thus, the cycle time may be the duration from the moment in time when the task is moved to the in-progress phase to the moment of time for the last commit that indicated the file as modified.

In some embodiments, step 14 comprises determining contributory time duration(s) for a file, wherein each contributory time duration ends with the moment of time for a commit that indicated the file as modified and starts with the moment of time of an earlier event (e.g., a directly previous event). The earlier event may be an earlier commit or the task migration to the in-progress phase. However, it is typically so that at least one contributory time duration of at least one file starts with the moment of time when the task migrated to the in-progress phase.

The cycle time of the file may then be determined by combination (e.g., accumulation) of the contributory time durations.

In some embodiments, the earlier commit when determining a contributory time duration may be a commit (e.g., the last commit) which indicates another file as modified. This is particularly relevant when it is known (or assumed) that the modification of the file under consideration can/should not commence before modification of the other file is completed, and/or when the same developer identity is associated with modifications of both files (assuming that the developer only performs modifications on one of the two files at a time).

In some embodiments, step 14 comprises determining an intermediate cycle time for a file for each of a plurality of combinations of task data item and version control data item. The plurality of combinations may comprise any suitable combinations (e.g., all combinations for a specific task, or all possible combinations). Then, the cycle time for the file may be provided as a combination (e.g., accumulation, average, mean value, etc.) of the intermediate cycle times.

FIG. 1B shows a method 20 for determining a project task time.

The third aspect of this disclosure shows a method 20 for determining a project task time in a software project, at an electronic device comprising a processing unit and a memory on which project artefacts, project management data and version control data is stored, the method comprising: obtaining S1 from the project management data, on the processing unit, a task data item, wherein the task data item comprises at least one task time stamp and a task ID (compare with step 11 of FIG. 1A); obtaining S2 from the version control data, on the processing unit, a version control data item, wherein the version control data item comprises a version ID, at least one version control time stamp, and a first list of modified project data files associated with the version ID (compare with step 12 of FIG. 1A); linking S3, on the processing unit, each version control data item to at least one task data item (compare with step 13 of FIG. 1A); determining S4, on the processing unit, the project task time for each modified project data file, wherein the project task time is based on the task data items and/or version control data items associated with the file (compare with step 14 of FIG. 1A); and storing S5 the project task time for each modified project data file on the memory (compare with step 16 of FIG. 1A).

The electronic device further comprises a display unit: displaying S6, on the display unit, the project task time for at least one of the modified project data files.

The method may comprise determining S9 the project task time based on a first task time, wherein the first task time is based on the time between a first task time stamp for a first project phase and an second task time stamp for a first project phase.

The method may comprise determining S10 the project task time based on a second task time, wherein the second task time is based on the time between the first task time stamp for the first project phase and a third task time stamp for a second project phase.

The method may comprise obtaining S2a a person ID for each change made in the modified project files of the first list of modified project data files; in response to determining that all changes are associated with the same person ID: determining the project task time based on a second task time, wherein the second task time is based on the time between a second task time stamp for the first project phase and a third task time stamp for a second project phase.

The task data item further comprises at least one person ID, the method may comprise determining S11 that all tasks and/or all modified project data files are associated with the same person ID.

The method may comprise determining S12 the project task time based on a task version time, wherein the task version time is based on the time between a version control time stamp from the version control data item and a task time stamp from the task data item corresponding to the version control data item.

The method may comprise determining S4a an impact measure based on an amount of modification of the modified project data files for each version control data item; and storing S5a on the memory the impact measure for at least one version control data item.

In an embodiment, amount of modification is the number of lines of code changed for each modified file corresponding to the version control data item.

The memory further stores software configuration data the method comprises architectural component information associated with each project artefact; the method further comprising: retrieving S7 a second list of modified project data files associated with an architectural component; determining S8 an architectural component project task time for an architectural component based on all project task times for the modified project data files associated with the architectural component.

The architectural component project task time is based on all project task times using a calculation comprised in the group of: the sum of all project task times, the mean value of all project task times, the median value of all project task times, the variance of all project task times, the standard deviation of all project task times.

The second list of modified project data files is retrieved by mapping S13 names of the modified files of first list of modified project data files using a preconfigured rule.

The method may comprise calculating S14 a second architectural component project task time for a second architectural component; and comparing the first and second architectural component project task times.

The method may comprise determining S15 for the modified file or the architectural component, a ranking based on the impact measure and the task time of the modified file or the architectural component.

The method may comprise sorting S16 the first list of modified project data files based on the project task time for each modified file; and displaying on the display unit the sorted list of modified project data files.

The method may comprise sorting S17 the second list of architectural components based on the architectural component project task time for each architectural component; and storing on the memory the sorted list of architectural component.

The disclosure allows an organization to get an accurate technical measure of their project task times on a design level, allowing the automated identification of delivery bottlenecks. A baseline measurement could also be obtained, to show the effect of future improvements. For example, if code is improved as part of a software refactoring, the disclosure allows the measurement of whether that improvement translate into shorter project task times, meaning shorter time-to-market.

At a module/component level (e.g., collection of files, service, microservice, sub-system, file with source code), with this data, the delivery bottlenecks are clear and an organization can make technical improvements that will shorten the lead times for any task involving that part of the codebase.

According to some embodiments, a computer program product comprises a non-transitory computer readable medium such as, for example, a universal serial bus (USB) memory, a plug-in card, an embedded drive, or a read only memory (ROM).

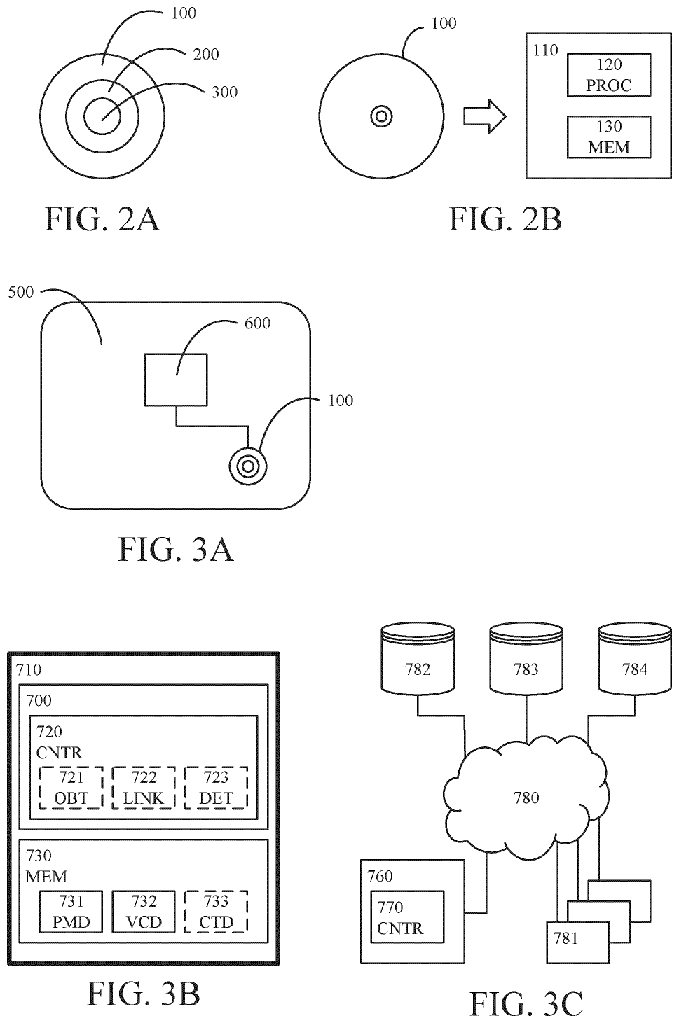

FIG. 2A shows a computer program product comprising a non-transitory computer readable medium 100, having thereon a computer program 200 comprising program instructions 300, the computer program being loadable into the processing unit and configured to cause execution of the method according to the first aspect when the computer program is run by the processing unit.

FIG. 2B illustrates an example computer readable medium 100 in the form of a compact disc (CD) ROM. The computer readable medium has stored thereon a computer program comprising program instructions. The computer program is loadable into a data processor (PROC; e.g., a data processing unit) 120, which may, for example, be comprised in an electronic device 110. When loaded into the data processor, the computer program may be stored in a memory (MEM) 130 associated with, or comprised in, the data processor. According to some embodiments, the computer program may, when loaded into, and run by, the data processor, cause execution of one or more method steps according to, for example, any of the methods illustrated in FIGS. 1A and 1B, or otherwise described herein.

FIG. 3A shows an apparatus 500 comprising controlling circuity 600 for performing a method of the disclosure, for example, any of the methods illustrated in FIGS. 1A and 1B, or otherwise described herein. The controlling circuitry 600 may be a (e.g., general purpose) processor. For example, the controlling circuitry may have access to program instructions for performing the method, the program instructions being loaded from a non-transitory computer readable medium 100 or being persistently stored within the apparatus 500. Alternatively or additionally, the controlling circuitry 600 may comprise specialized circuitry specifically adapted to perform one or more of the method steps described herein.

FIG. 3B schematically illustrates an example electronic data-processing apparatus 700 according to some embodiments. The apparatus 700 may be comprised in an electronic device 710 (e.g., a computer, or similar). The apparatus 700 may, for example be configured to cause performance of (e.g., perform) one or more method steps according to, for example, any of the methods illustrated in FIGS. 1A and 1B, or otherwise described herein.

The apparatus 700 is configured for determination of (e.g., configured to determine) a cycle time in a software project, wherein the cycle time relates to a software project file—or collection of files—in the software project.

The apparatus 700 comprises a controller (CNTR; e.g., controlling circuitry or a control module) 720. The controller 720 may be a (e.g., general purpose) processor. Alternatively or additionally, the controller 720 may comprise specialized circuitry specifically adapted to perform one or more of the method steps described herein.

The controller 720 is configured to cause a task data item and a version control data item to be obtained (compare with steps 11 and 12 of FIG. 1A).

To this end, the controller 720 may comprise, or be otherwise associated with (e.g., connected, or connectable, to), an obtainer (OBT, e.g., obtaining circuitry or an obtainer module) 721. The obtainer 721 may be configured to obtain the task data item and the version control data item.

The task data item is obtained by accessing project management data (PMD) 731, and the version control data item is obtained by accessing version control data (VCD) 732. In the example of FIG. 3B, the project management data and the version control data are stored on memory circuitry (MEM) 730 comprised in the apparatus 710. In other embodiments, the project management data and/or the version control data may be stored on (respective or the same) memory circuitry otherwise associated with (e.g., operatively connected to) the apparatus 710.

The project management data is indicative of migration of software project tasks through different project phases including an in-progress phase, and the task data item comprises a task identifier indicating a task corresponding to the task data item, and a task time stamp indicating when the task migrated to the in-progress phase.

The version control data is indicative of software commits of the software project. The version control data item relates to one or more software commit and comprises (for each related software commit) a commit-specific version control time stamp indicating when the software commit was performed, and a commit-specific list of software project files that were modified in association with the software commit.

In some embodiments, the controller 720 is configured to cause linking of the version control data item to the task data item, e.g., when the software commits of the version control data item are performed for the task corresponding to the task data item (compare with step 13 of FIG. 1A).

To this end, the controller 720 may comprise, or be otherwise associated with (e.g., connected, or connectable, to), a linker (LINK, e.g., linking circuitry or a linkage module) 722. The linker 722 may be configured to link the version control data item to the task data item.

The controller 720 is also configured to cause—responsive to the version control data item being linked to the task data item—determination of the cycle time of a software project file in a commit-specific list (compare with step 14 of FIG. 1A) by determination of time duration between the task time stamp and the version control time stamp specific for the commit of the commit-specific list. In some embodiments, the controller 720 is also configured to cause determination of the cycle time of a software project collection of files as a combination of the cycle times of software project files in the collection (compare with step 15 of FIG. 1A).

To this end, the controller 720 may comprise, or be otherwise associated with (e.g., connected, or connectable, to), a determiner (DET, e.g., determining circuitry or a determination module) 723. The determiner 723 may be configured to determine the cycle time. In some embodiments, the controller 720 is also configured to cause an action to be performed based on the cycle time(s) (compare with step 16 of FIG. 1A). For example, the controlling circuitry may be further configured to cause rendering of the cycle time(s) or indication(s) thereof via a user interface (e.g., to provide continuous guidance as exemplified above), interaction with the project management tool (e.g., by creating/updating/removing a cycle time improvement task as exemplified above), and/or storing of the cycle time of the software project file—or an indication thereof—in third memory circuitry (illustrated in FIG. 3B as cycle time data, CTD, 733 being stored on memory circuitry 730).

FIG. 3C schematically illustrates an example electronic data-processing apparatus 760 according to some embodiments. The apparatus 760 may, for example, be comprised in a cloud server which is part of a cloud computing system (represented by 780). The apparatus 760 may, for example be configured to cause performance of one or more method steps according to, for example, any of the methods illustrated in FIGS. 1A and 1B, or otherwise described herein.

The apparatus 760 is configured for determination of a cycle time in a software project, wherein the cycle time relates to a software project file—or collection of files—in the software project.

The apparatus 760 comprises a controller (CNTR; e.g., controlling circuitry or a control module) 770. The controller 770 may be configured to cause similar functions as explained above for FIG. 3B. However, in the scenario of FIG. 3C, the actual performance of one or more of the functions (e.g., obtaining task data item, obtaining version control data item, linking, determining, and performing action) may take place in one or more other nodes 781 of the cloud computing system. Alternatively or additionally, one or more of the project management data (PMD), the version control data (VCD), and the cycle time data (CTD) may reside in (same or separate) storage nodes 782, 783, 784 of the cloud computing system; which storage nodes may, or may not, be co-located with the apparatus 760.

It should be noted that details such as, for example, features and/or advantages, described otherwise herein (e.g., in connection with FIG. 1A) may be equally applicable—mutatis mutandis—to the apparatus 700 of FIG. 3B and/or the apparatus 760 of FIG. 3C; even if not explicitly mentioned in connection thereto.

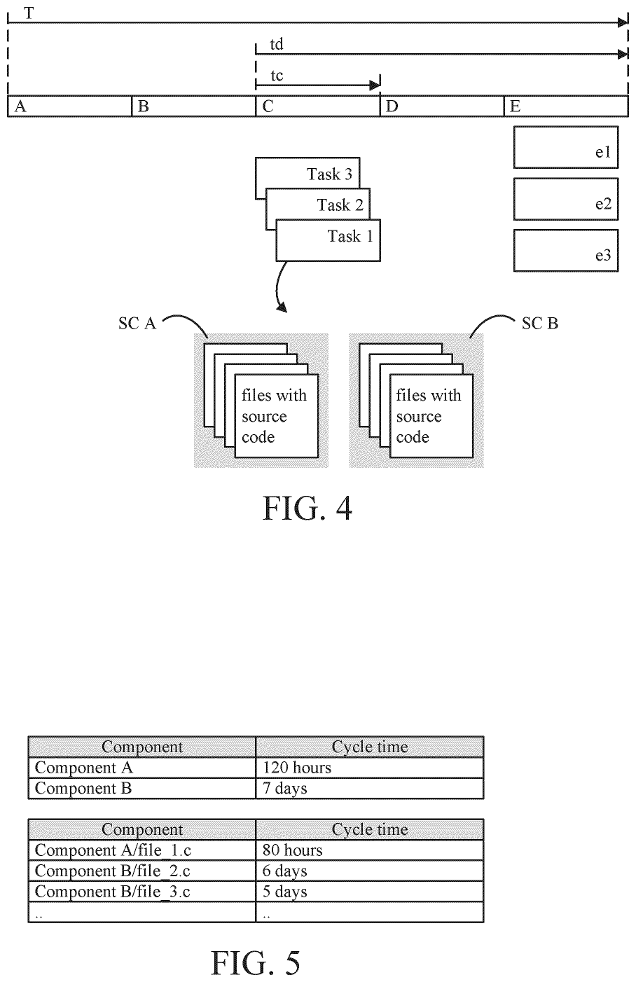

FIG. 4 shows a project management dashboard and the effect of the disclosure on modified files. Thus, FIG. 4 illustrates some aspects of a project management tool.

The product management dashboard may include different project phases, such as backlog A, prioritized B, in progress C, ready for test D and completed E. All phases sum up to a total lead time for all tasks T. Completed work is illustrated as e1, e2, e3 under “completed” E. Ongoing work under “in progress” C may be organized as tasks, e.g., task 1, task 2, task 3. This is where the cycle time for coding tc is present. The time in development td is associated with the phases in progress C, ready for test D and completed E.

The cycle time representation tc illustrates a cycle time determined for a task without using version control data. Some embodiments provide a more useful cycle time determination: by increasing the granularity of the cycle time determination (cycle time per file and/or per collection of files), and by using version control data together with project management data from the project management tool to provide a more accurate metric of the actual time spent on code modifications.

Each task may be represented by a task data item, and may be associated with different files with source code and/or software components (wherein a software component may be seen as an example of a collection of files). For example, Task 1 maybe associated with software component A, SC A, and/or software component B, SC B. This may be done, for example, through identification with a task ID.

In an embodiment, using the information shown in the project management dashboard, it could be calculated that, as a mean time, tasks spend 5 days in “In Progress” and 2 days in “Ready for Test” giving a total project task time average of 7 days. But finding where in the source code the costs were accumulated from presents a serious technical problem, as a large system contains tens of thousands of files with source code. This is addressed by some embodiments as explained and exemplified herein.

FIG. 5 shows an embodiment of a table comprising a sorted list of architectural components (e.g., software components or other collections of files) and a sorted list of modified project data files based on project task time. Thus, FIG. 5 may be seen as illustrating the increased granularity of the cycle time determination.

As already mentioned, some embodiments provide a way of determining project task times at a component and/or file level. The table shows that the main bottleneck is Component A (120 hours corresponding to, e.g., 15 days). Inside Component A, the table shows that the file-level bottleneck is file_1.c (80 hours corresponding to, e.g., 10 days). The software organization can now focus improvements to file_1.c to shorten their cycle times.

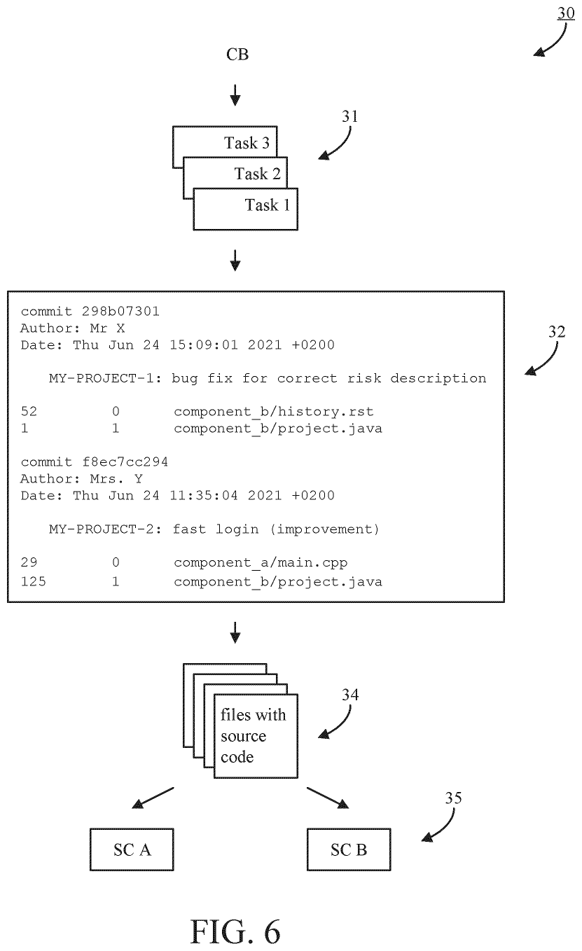

FIG. 6 shows an illustration 30 of how input data is used to calculate granular cycle times at the design level. FIG. 6 may be compared with method 10 of FIG. 1A. The input in FIG. 6 is a codebase CB and information from a product management tool.

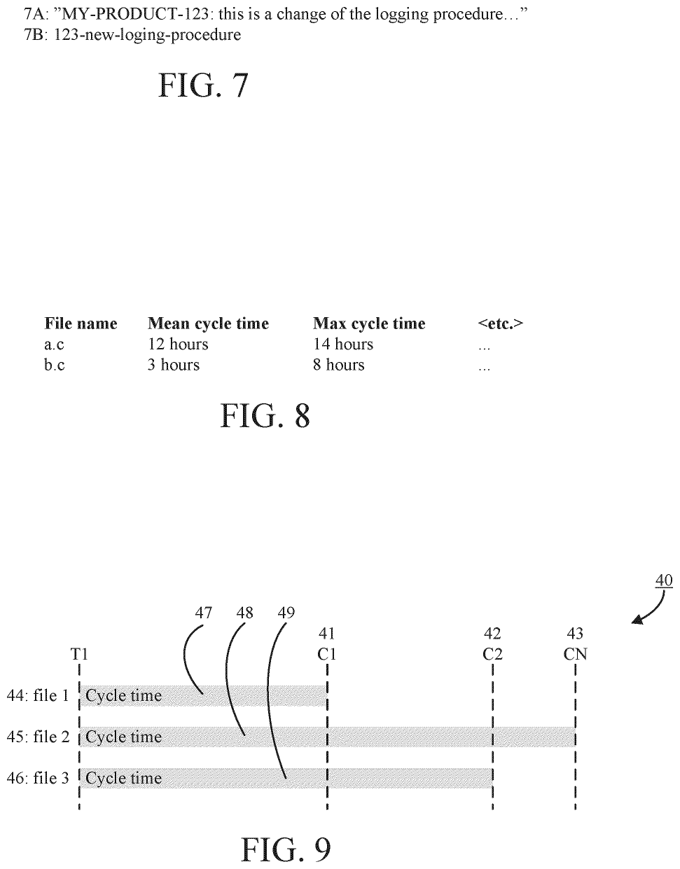

In various embodiments, the method illustrated by FIG. 6 may use various inputs:
Development tasks: These are represented by the task data items, the items captured in a product management tool like Jira or Trello. This is used to identify the work in progress and to calculate the overall cycle times.
Version-control data: Version-control is traditionally used to coordinate changes to a codebase and as a backup system of historic source code versions. Version control data may be viewed as a record of the previous development work, and the version control data comprises version control data items. The version-control data may be seen as part of the codebase according to some embodiments.
Link from version-control to tasks: Some embodiments are based on finding a relationship between a code change and a development task. The following are three example variations:
   Free text comment: Modern version-control tools like Git provides a free text comment that explains a code change. These comments often contain a reference to the corresponding development task. An example is seen in FIG. 7 (7A) below, where “123” (e.g., provided in, or in relation to, the version control data) indicates a link to the task with task ID 123.
   Branch name: Version-control branches can be prefixed with a task ID. An example is seen in FIG. 7 (7B) below, where “123” (e.g., provided in, or in relation to, the version control data) indicates a link to the task with task ID 123.
   Pull and Merge Requests: Pull Requests are commonly used to review completed work. The Pull Requests often contain a mention of the Task ID that the work refers to.

FIG. 6 illustrates an embodiment of how this input data may be used to calculate granular cycle times at the design level:

Step #1 (31; compare with step 11 of FIG. 1A) is a call to the product management tool API (application programming interface) where we extract information about Tasks and their Transition Times (e.g. when did the task transition-migrate-into an “In Progress” C state).

Step #2 (32; compare with steps 12 and 13 of FIG. 1A) relates the specific Tasks fetched in #1 to commits in version-control. This is done by extracting the Task ID from the commit using one of the three strategies defined above under Link from version-control to tasks. Some different link indications are illustrated in FIG. 6 (e.g., “MY-PROJECT-X”, where X provided in the version control data indicates a link to the task with task ID X). After this step, there is a list of Tasks per source code file. An example:

| File name | Modified in task | Commit |
|---|---|---|
| a.c | 123 | #1 |
| b.c | 123 | #1 |
| a.c | 234 | #2 |
| . . . | . . . | . . . |

Step #3 (34; compare with step 14 of FIG. 1A) may be particularly important for some embodiments. For example, the problem of determining the cycle time(s) may be solved using the approach detailed any of in FIGS. 9, 11A, and 11B below. An example result of this step is seen in FIG. 8 below.

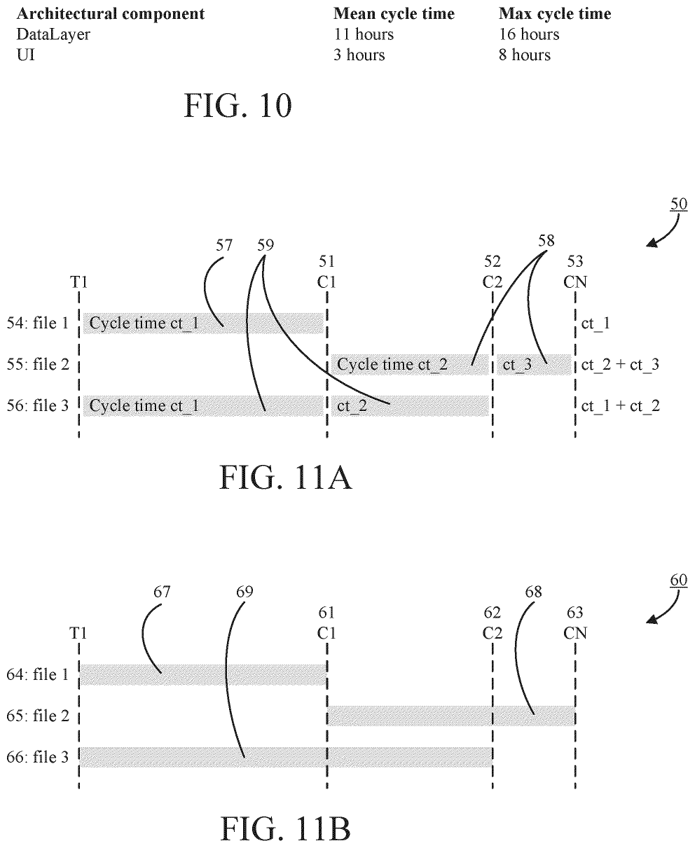

Step #4 (35; compare with step 15 of FIG. 1A) aggregates the file-level data at the level of architectural components (SC A, SC B; an example of collections of files). An architectural component can be a software layer, a microservice, or a software component. The aggregation is done by mapping file names using pre-configured rules for assigning content to architectural components (e.g., the rule may indicate, for an architectural component, which files it comprises). For example, one rule could be “every source code file located under src/application/data/belongs to the architectural component DataLayer”. An example result of this step is seen in FIG. 10 below.

FIG. 7 (part 7A) shows an example of free text data as input into a version control system. In this case, MY-PRODUCT refers to a Jira board and 123 is the Task ID on that Jira board.

FIG. 7 (part 7B) shows an example of a version-control branch that can be prefixed with a task ID. In this case, the branch prefix—123—is the Task ID.

FIG. 8 shows an example of the result of Step 2 and/or Step 3 of FIG. 6 above, a list of files with cycle time data.

FIG. 9 shows an example 40 of the combination of the transition time stamp from the product management tool with the commit time stamp of the version control tool. Analysis of a task that have moved into “In Progress” C at a moment in time T1, is divided in relation to commits (commit #1 C1—at time 41, commit #2 C2—at time 42, . . . , commit #N CN—at time 43).

File 1 (44) was modified only in relation to commit C1 (appearing in the commit-specific list of C1). Thus, C1 is the last commit for file 1, and the cycle time 47 for file 1 may be determined as the duration of time from T (indicated by the task time stamp) to 41 (indicated by the version control time stamp associated with C1).

File 2 (45) was modified only in relation to commits C2 and CN (appearing in the commit-specific lists of both C2 and CN). Thus, CN is the last commit for file 2, and the cycle time 48 for file 2 may be determined as the duration of time from T (indicated by the task time stamp) to 43 (indicated by the version control time stamp associated with CN).

File 3 (46) was modified only in relation to commits C1 and C2 (appearing in the commit-specific lists of both C1 and C2). Thus, C2 is the last commit for file 3, and the cycle time 49 for file 3 may be determined as the duration of time from T (indicated by the task time stamp) to 42 (indicated by the version control time stamp associated with C2).

This is an elaboration on Step #3 of FIG. 6 above. That is, some embodiments combines the transition time stamp from the product management tool with the commit time stamp from version-control to determine the cycle time.

FIG. 10 shows an example of the result of step 4 of FIG. 6 above, a list of architectural components with cycle time data.

FIG. 11A shows an example 50 of the cycle time calculation, which is a variation of that as shown in FIG. 9 relating to determining contributory time duration(s) for a file.

Analysis of a task that have moved into “In Progress” C at a moment in time T1, is divided in relation to commits (commit #1 C1—at time 51, commit #2 C2—at time 52, . . . , commit #N CN—at time 53).

File 1 (54) was modified only in relation to commit C1. Thus, C1 is the only commit for file 1, and the cycle time 57 for file 1 may be determined as the duration of time from T (indicated by the task time stamp) to 51 (indicated by the version control time stamp associated with C1). This corresponds to determining one contributory time duration (ct_1) of file 1.

File 2 (55) was modified only in relation to commits C2 and CN. Thus, two contributory time durations (ct_2 and ct_3) may be determined for file 2, and the cycle time 58 for file 2 may be determined by accumulation of the two contributory time durations (ct_2+ct_3). The contributory time duration ct_2 may be determined as the duration of time from 51 (indicated by the version control time stamp associated with C1) to 52 (indicated by the version control time stamp associated with C2), and the contributory time duration ct_3 may be determined as the duration of time from 52 (indicated by the version control time stamp associated with C2)—or from the time associated with a later commit—to 53 (indicated by the version control time stamp associated with CN).

File 3 (56) was modified only in relation to commits C1 and C2. Thus, two contributory time durations (ct_1 and ct_2) may be determined for file 3, and the cycle time 59 for file 3 may be determined by accumulation of the two contributory time durations (ct_1 +ct_2). The contributory time duration ct_1 may be determined as the duration of time from T (indicated by the task time stamp) to 51 (indicated by the version control time stamp associated with C1), and the contributory time duration ct_2 may be determined as above.

Thus, each contributory time duration ends with the moment of time for a commit that indicated the file as modified and starts with the moment of time of an earlier event (e.g., a directly previous event). The earlier event may be an earlier commit or the task migration to the in-progress phase.

In some embodiments, the earlier commit when determining a contributory time duration may be a commit (e.g., the last commit) which indicates another file as modified. This is particularly relevant when it is known (or assumed) that the modification of the file under consideration can/should not commence before modification of the other file is completed, and/or when the same developer identity is associated with modifications of both files (assuming that the developer only performs modifications on one of the two files at a time).

Hence, in some of its applications, FIG. 11A may be seen as exemplifying a situation when the system determines that all tasks are performed by the same person and when it is decided that some tasks then need to be performed after another task is finished, or at least completed to a certain commit.

FIG. 11B shows an example 60 of the cycle time calculation, which is a variation of that as shown in FIG. 9.

Analysis of a task that have moved into “In Progress” C at a moment in time T1, is divided in relation to commits (commit #1 C1—at time 61, commit #2 C2—at time 62, . . . , commit #N CN—at time 63).

File 1 (64) was last modified in relation to commit C1, and the cycle time 67 for file 1 may be determined as the duration of time from T (indicated by the task time stamp) to 61 (indicated by the version control time stamp associated with C1).

File 2 (65) was last modified in relation to commit CN, and its modification is conditioned on modification of file 1 (e.g., due to that file 2 is not conveniently modified before modifications of file 1 are completed, and/or due to that the same person has made modifications to both files). Thus, the cycle time 68 for file 2 may be determined as the duration of time from 61 (indicated by the version control time stamp associated with C1; the last commit of file 1) to 63 (indicated by the version control time stamp associated with CN).

File 3 (66) was last modified in relation to commit C2, and the cycle time 69 for file 3 may be determined as the duration of time from T (indicated by the task time stamp) to 62 (indicated by the version control time stamp associated with C2).

The determination of 68 may be seen as a determination of contributory time duration spanning over several commits.

The principles illustrated in FIGS. 11A and 11B may be generalized. Thus, there may be a file with two or more contributory time durations which have gaps of time between them. Each contributory time duration may span a time between two directly subsequent events (events including migration to in-progress phase and commits) and/or between two events that have one or more other event in between them. The end of a contributory time duration may be the time of a commit that indicates the file under consideration as modified. The start of a contributory time duration may be the time of the event that is directly previous to the event of the end of a contributory time duration, or an earlier event (e.g., a commit—such as the last commit—that indicates another file as modified). The file under consideration and the other file may have some conditional relationship which makes it probable that modification of the file under consideration does not commence before modification of the other file is completed. All commits that indicates the file under consideration as modified may be used for providing a contributory time duration, or only some commits that indicates the file under consideration as modified may be used for providing a contributory time duration (e.g., discarding commits that fall before the last commit of another—related—file.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an electronic apparatus such as exemplified above.

Embodiments may appear within an electronic apparatus comprising arrangements, circuitry, and/or logic according to any of the embodiments described herein. Alternatively or additionally, an electronic apparatus may be configured to perform methods according to any of the embodiments described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

### SOME EXAMPLES ILLUSTRATING VARIOUS EMBODIMENTS

1. A method for determining a cycle time in a software project, at an electronic device comprising a processing unit and a memory on which project artefacts, project management data and version control data is stored, the method comprising:
obtaining (S1) from the project management data, on the processing unit, a task data item, wherein the task data item comprises at least one task time stamp and a task ID;
obtaining (S2) from the version control data, on the processing unit, a version control data item, wherein the version control data item comprises a version ID, at least one version control time stamp, and a first list of modified project data files associated with the version ID;
linking (S3), on the processing unit, each version control data item to at least one task data item;
determining (S4), on the processing unit, the cycle time for each modified project data file, wherein the cycle time is based on the task data items and/or version control data items associated with the file;
storing (S5) the cycle time for each modified project data file on the memory.

2. The method of example 1, wherein the electronic device further comprises a display unit: displaying (S6), on the display unit, the cycle time for at least one of the modified project data files.

3. The method of any one of the preceding examples, further comprising:
determining the cycle time based on a first task time, wherein the first task time is based on the time between a first task time stamp for a first project phase and an second task time stamp for a first project phase.

4. The method of any one of the preceding examples, further comprising:
determining the cycle time based on a second task time, wherein the second task time is based on the time between the first task time stamp for the first project phase and a third task time stamp for a second project phase.

5. The method according to any of examples 1-3, further comprising;
obtaining (S2a) a person ID for each change made in the modified project files of the first list of modified project data files;
in response to determining that all changes are associated with the same person ID:
   determining the cycle time based on a second task time, wherein the second task time is based on the time between a second task time stamp for the first project phase and a third task time stamp for a second project phase.

6. The method according to example 5, wherein the task data item further comprises at least one person ID, the method further comprising:
determining that all tasks and/or all modified project data files are associated with the same person ID.

7. The method of any one of the preceding examples, further comprising:
determining the cycle time based on a task version time, wherein the task version time is based on the time between a version control time stamp from the version control data item and a task time stamp from the task data item corresponding to the version control data item.

8. The method of any of the preceding examples, further comprising:
determining (S4a) an impact measure based on an amount of modification of the modified project data files for each version control data item; and
storing (S5a) on the memory the impact measure for at least one version control data item.

9. The method of example 8, wherein the amount of modification is the number of lines of code changed for each modified file corresponding to the version control data item.

10. The method according to any of the preceding examples, wherein the memory further stores software configuration data comprising architectural component information associated with each project artefact;
the method further comprising:
retrieving (S7) a second list of modified project data files associated with an architectural component;
determining (S8) an architectural component cycle time for an architectural component based on all cycle times for the modified project data files associated with the architectural component.

11. The method according to example 10, wherein the architectural component cycle time is based on all cycle times using a calculation comprised in the group of: the sum of all cycle times, the mean value of all cycle times, the median value of all cycle times, the variance of all cycle times, the standard deviation of all cycle times.

12. The method according to example 10, wherein the second list of modified project data files is retrieved by mapping names of the modified files of first list of modified project data files using a preconfigured rule.

13. A computer program product comprising a non-transitory computer readable medium (100), having thereon a computer program (200) comprising program instructions (300), the computer program being loadable into a processing unit and configured to cause execution of the method according to any of the preceding examples when the computer program is run by the processing unit.

14. An apparatus (500) comprising a controlling circuity (600) for performing the method of any of the proceeding examples.

1. An electronic data-processing apparatus configured for determination of a cycle time in a software project, wherein the cycle time relates to a software project file in the software project, the apparatus comprising controlling circuitry configured to cause:
a task data item to be obtained by accessing project management data stored on first memory circuitry associated with the apparatus, wherein the project management data is indicative of migration of software project tasks through different project phases including an in-progress phase, wherein the in-progress phase is a phase where actual modifications to code is performed for the software project, and wherein the task data item comprises:
a task identifier indicating a task corresponding to the task data item; and
a task time stamp indicating when the task migrated to the in-progress phase;
a version control data item to be obtained by accessing version control data stored in second memory circuitry associated with the apparatus, wherein the version control data is indicative of software commits of the software project, wherein the version control data item relates to a plurality of software commits and comprises, for each related software commit:
a commit-specific version control time stamp indicating when the software commit was performed; and
a commit-specific list of software project files that were modified in association with the software commit; responsive to the version control data item being linked to the task data item:
determination of the cycle time of a software project file in a commit-specific list by determination of time duration between the task time stamp and the version control time stamp specific for the commit of the commit-specific list; and
provision, based on respective determined cycle times of software project files, of guidance to a user regarding respective time required for modification of different portions of a codebase.

2. The apparatus of claim 1, wherein the controlling circuitry is further configured to cause the cycle time of the software project file to be stored in third memory circuitry.

3. The apparatus of claim 1, wherein the controlling circuitry is further configured to cause linking of the version control data item to the task data item when the software commits of the version control data item are performed for the task corresponding to the task data item.

4. The apparatus of claim 1, wherein the controlling circuitry is further configured to cause linking of the version control data item to the task data item when the version control data item pertains to the task identifier of the task data item.

5. The apparatus of claim 4, wherein the version control data item pertaining to the task identifier of the task data item comprises one or more of:
the task identifier appearing in a code comment of a software project file in a commit-specific list of the version control data item;
the task identifier being indicated for a version control branch comprising the one or more software commit of the version control data item; and
the task identifier being indicated for a pull request, or a merge request, invoking the one or more software commit of the version control data item.

6. The apparatus of claim 1, wherein the version control time stamp used for the determination of the cycle time of the software project file indicates the last commit of the version control data item that has the software project file in its commit-specific list.

7. The apparatus of claim 1, wherein the controlling circuitry is further configured to cause determination of the cycle time of a software project file in a commit-specific list by determination of contributory time duration between an earlier version control time stamp and the version control time stamp specific for the commit of the commit-specific list, wherein the earlier version control time stamp is specific for a commit which is indicated by the version control data item.

8. The apparatus of claim 7, wherein the earlier version control time stamp is specific for a commit which is directly previous to that of the commit-specific list.

9. The apparatus of claim 7, wherein the controlling circuitry is further configured to cause, for a software project file, determination of contributory time duration for a plurality of commits that each have the software project file in their commit-specific list, and determination of the cycle time of the software project file by combination of contributory time durations.

10. The apparatus of claim 7, wherein the software project file is a first software project file, and the earlier version control time stamp is specific for a commit which has a second software project file in its commit-specific list.

11. The apparatus of claim 10, wherein modification of the first software project file is conditioned on modification of the second software project file being completed.

12. The apparatus of claim 10, wherein modifications of the first and second software project files are associated with a same developer identity.

13. The apparatus of claim 1, wherein the controlling circuitry is further configured to cause determination of an intermediate cycle time for each of a plurality of combinations of task data item and version control data item of the software project, and provide the cycle time of the software project file as a combination of the intermediate cycle times.

14. The apparatus of claim 1, wherein the controlling circuitry is further configured to cause determination of the cycle time of a software project collection of files as a combination of the cycle times of software project files in the collection.

15. The apparatus of claim 1, wherein the version control data item further comprises, for each related software commit, a version identifier indicating the software commit.

16. A computer-implemented method for determining a cycle time in a software project, wherein the cycle time relates to a software project file in the software project, the method comprising:
obtaining a task data item by accessing project management data stored on first memory circuitry, wherein the project management data is indicative of migration of software project tasks through different project phases including an in-progress phase, wherein the in-progress phase is a phase where actual modifications to code is performed for the software project, and wherein the task data item comprises:
a task identifier indicating a task corresponding to the task data item; and
a task time stamp indicating when the task migrated to the in-progress phase;
obtaining a version control data item by accessing version control data stored in second memory circuitry, wherein the version control data is indicative of software commits of the software project, wherein the version control data item relates to a plurality of software commits and comprises, for each related software commit:
a commit-specific version control time stamp indicating when the software commit was performed; and
a commit-specific list of software project files that were modified in association with the software commit;
responsive to the version control data item being linked to the task data item:
determining the cycle time of a software project file in a commit-specific list by determination of time duration between the task time stamp and the version control time stamp specific for the commit of the commit-specific list; and
providing, based on respective determined cycle times of software project files, guidance to a user regarding respective time required for modification of different portions of a codebase.

17. (canceled)

18. A computer program product comprising a non-transitory computer readable medium, having thereon a computer program comprising program instructions, the computer program being loadable into a processing unit and configured to cause execution of the method according to claim 16 when the computer program is run by the processing unit.
